(19) United States
(12) Patent Application Publication
(10) Pub. No.: US 2021/0223570 A1
(43) Pub. Date: Jul. 22, 2021

(54) EYEGLASS TEMPLE

(71) Applicant: Dongguan QBM Optics Technology Co., Ltd., Dongguan City (CN)

(72) Inventor: Jianzhong YUAN, Dongguan City (CN)

(21) Appl. No.: 16/746,026

(22) Filed: Jan. 17, 2020

(51) Int. Cl. G02C 5/18

(52) U.S. Cl. CPC G02C 5/18

(57) ABSTRACT

An eyeglass temple includes an eyeglass temple body with a curved section and a support section connected to the curved section. The eyeglass temple body is made of resin and has a top wall groove formed along the lengthwise direction of a top wall of the eyeglass temple body and has a long steel strip installed in the top wall groove; a notch formed on a bottom wall of the curved section, a T-shaped groove formed along the lengthwise direction of a bottom surface of the notch, a short steel strip fitted into the T-shaped groove, and a silicone strip installed into the notch. Since the eyeglass temple body is made of resin and has the long steel strip installed in the T-shaped groove and the short steel strip and silicone strip installed in the curved section, the eyeglass temple features high strength, low cost, and outstanding comfortability.

### FIELD OF INVENTION

The present invention relates to the technical field of eyeglasses, in particular to an eyeglass temple.

### BACKGROUND OF INVENTION

### Description of the Related Art

Eyeglass temple is a part of eyeglasses resting behind a wearer's ear to support an eyeglass frame. However, the conventional eyeglass temples have the drawbacks of low strength, high cost, and poor comfortability and fail to satisfy the increasingly higher requirements for eyeglass temples.

Obviously, the conventional eyeglass temples require improvements.

### SUMMARY OF THE INVENTION

To overcome the drawbacks of the conventional eyeglass temples, the invention provides an eyeglass temple with the features of high strength, low cost and outstanding comfortability.

To achieve the aforementioned and other objectives, the present invention provides an eyeglass temple, comprising: an eyeglass temple body with a curved section and a support section coupled to the curved section, and the eyeglass temple body being made of resin, and a top wall groove being formed along the lengthwise direction of a top wall of the eyeglass temple body, a long steel strip being installed into the top wall groove, and the curved section having a notch formed on a bottom wall thereof, a T-shaped groove formed along the lengthwise direction of the bottom surface of the notch, a short steel strip installed and fitted into the T-shaped groove, and a silicone strip installed into the notch.

Compared with the prior art, the present invention has the following advantages:

Since the eyeglass temple body is made of resin and has the long steel strip installed in the eyeglass temple body and the short steel strip and the silicone strip installed in the curved section, the eyeglass temple of this invention has the features of high strength, low cost, and outstanding comfort ability.

### BRIEF DESCRIPTION OF THE DRAWINGS

FIG. 1 is a schematic view of an eyeglass temple of the present invention;

FIG. 2 is an exploded view of an eyeglass temple of the present invention; and

FIG. 3 is a cross-sectional view of an eyeglass temple of the present invention.

### DESCRIPTION OF NUMERALS USED IN THE DRAWINGS

1: Eyeglass temple body; 11: Curved section; 12: Support section, 13: Top wall groove; 2: Long steel strip; 111: Notch; 112: T-shaped groove; 3: Short steel strip; 4: Silicone strip.

### DESCRIPTION OF THE PREFERRED EMBODIMENTS

To make it easier for our examiner to understand the objective of the invention, its structure, innovative features, and performance, we use a preferred embodiment together with the attached drawings for the detailed description of the invention.

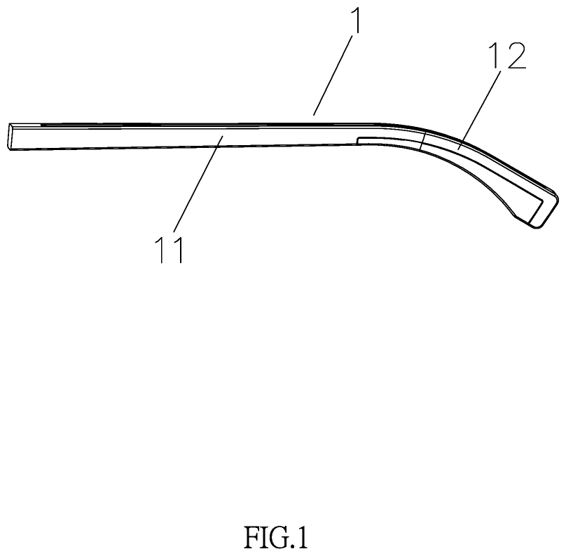

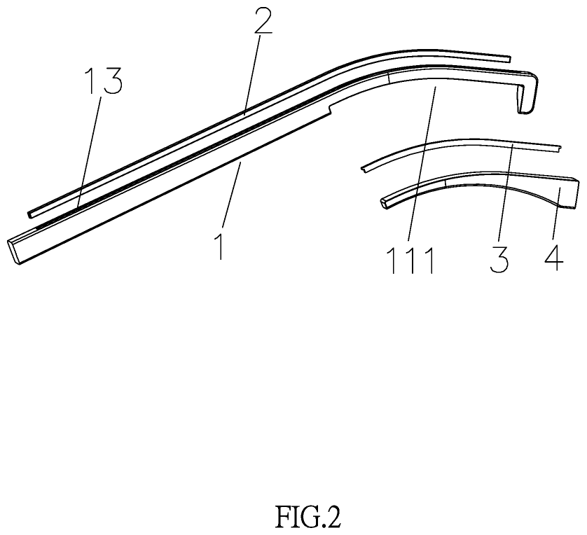

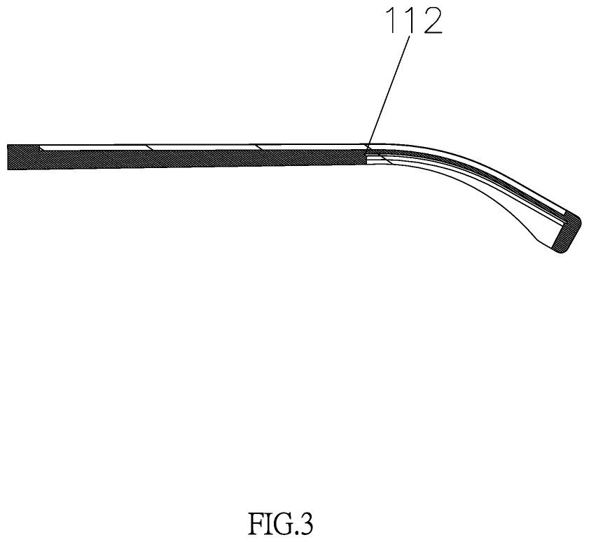

With reference to FIGS. 1 to 3 for an eyeglass temple of the present invention, the eyeglass temple comprises an eyeglass temple body 1 with a curved section 11 and a support section 12 coupled to the curved section 11, wherein the eyeglass temple body 1 is made of resin, and has a top wall groove 13 formed along the lengthwise direction of a top wall of the eyeglass temple body 1, and a long steel strip 2 installed in the top wall groove 13; and the curved section 11 has a notch 111 formed on a bottom wall of the curved section 11, and a T-shaped groove 112 formed along the lengthwise direction of the bottom surface of the notch 111, a short steel strip 3 installed and fitted into the T-shaped groove 112, and a silicone strip 4 installed in the notch 111.

In the present invention, the eyeglass temple body is made of resin and the silicone strip is made of silicone. Compared with the prior art with the eyeglass temple body made of silicone, the cost of this invention is lower. In the meantime, the silicone strip is in contact with the rear part of a wearer's ear, so as to improve the wearing comfortability of the wearers. The structural design with the long steel strip installed in the eyeglass temple body and the short steel strip installed in the curved section improves the strength of the eyeglass temple body significantly.

In an assembling process of the present invention, the short steel strip and the silicone strip are thermally bonded with each other by a thermal bonding method, and then the short steel strip is inserted into the T-shaped groove, and the silicone strip is installed in to the notch of the curved section, and finally the long steel strip is installed in to the top wall groove to complete the assembling.

In summation, the aforementioned structural design of the present invention overcomes the drawbacks of the prior art and has the features of feasible structure, skillful design, low cost, and outstanding comfortability, so that this invention has high market value and great market potential.

While the invention has been described by means of specific embodiments, numerous modifications and variations could be made thereto by those skilled in the art without departing from the scope and spirit of the invention set forth in the claims.

What is claimed is:

1. An eyeglass temple, comprising: an eyeglass temple body with a curved section and a support section coupled to the curved section, and the eyeglass temple body being made of resin, and a top wall groove being formed along the lengthwise direction of a top wall of the eyeglass temple body, a long steel strip being installed into the top wall groove, and the curved section having a notch formed on a bottom wall thereof, a T-shaped groove formed along the lengthwise direction of the bottom surface of the notch, a short steel strip installed and fitted into the T-shaped groove, and a silicone strip installed into the notch.
